(19) United States
(12) Patent Application Publication
(10) Pub. No.: US 2007/0096630 A1
(43) Pub. Date: May 3, 2007

(54) Field emission backlight unit and its method of operation

(76) Inventors: Deuk-Seok Chung, Seongnam-si (KR); Byong-Gwon Song, Seoul (KR); Yong-Chul Kim, Seoul (KR); Jun-Hee Choi, Seongnam-si (KR); Moon-Jin Shin, Yongin-si (KR)

Correspondence Address: Robert E. Bushnell, Suite 300, 1522 K Street, N. W., Washington, DC, 20005, US

(21) Appl. No.: 11/581,351

(22) Filed: Oct. 17, 2006

(30) Foreign Application Priority Data
Nov. 2, 2005 (KR) 10-2005-0104360

(51) Int. Cl. H01J 1/62

(52) U.S. Cl. 313/497

(57) ABSTRACT

A field emission backlight unit includes: an upper substrate and a lower substrate spaced apart from each other and facing each other; an anode electrode arranged on a lower surface of the upper substrate; a phosphor layer arranged on a lower surface of the anode electrode; cathode electrodes arranged on an upper surface of the lower substrate; an insulating layer having cavities adapted to expose the cathode electrode; a flat panel shaped gate electrode arranged on the insulating layer and having gate apertures respectively connected to the cavities; and an emitter arranged on the cathode electrode; the gate electrode is adapted to receive a ground voltage and the cathode electrode is adapted to receive a negative voltage

### CLAIM OF PRIORITY

This application makes reference to, incorporates the same herein, and claims all benefits accruing under 35 U.S.C. §119 from an application for FIELD EMISSION TYPE BACKLIGHT UNIT AND METHOD OF OPERATING THE SAME earlier filed in the Korean Intellectual Property Office on the 2^{nd} of Nov. 2005 and there duly assigned Serial No. 10-2005-0104360.

### BACKGROUND OF THE INVENTION

1. Field of the Invention

The present invention relates to a field emission backlight unit, and more particularly, to a field emission backlight unit with increased luminous efficiency and its method of operation.

2. Description of the Related Art

Flat panel displays can be generally divided into emissive displays and passive displays. Emissive displays include Cathode Ray Tubes (CRTs), Plasma Display Panels (PDPs), and Field Emission Displays (FEDs), and passive displays include Liquid Crystal Displays (LCDs). Of these displays, LCDs have the advantages of being light weight and having a low power consumption. However, they do not generate light. That is, the LCDs display an image using light from an external device. Therefore, the image cannot be seen in a dark place. To solve this disadvantage, backlight units are installed behind the LCDs.

Conventional backlight units mainly use Cold Cathode Fluorescent Lamps (CCFLs) as a line luminescence source and Light Emitting Diodes (LEDs) as a point luminescence source. However, conventional backlight units have high manufacturing costs due to their structural complexity, and have a high power consumption due to light reflection and transmittance being required since the light sources are located on one side of the backlight unit. In particular, as the size of an LCD increases, the achievement of uniform brightness is more difficult.

Recently, to solve the above drawbacks, flat field emission backlight units have been developed. The flat field emission backlight units have low power consumption compared to the backlight units that uses the conventional CCFLs, and have an advantage of having relatively uniform brightness on a wide light emitting region. The field emission backlight unit can be used for illumination.

In a field emission backlight unit, an upper substrate and a lower substrate are spaced apart and face each other. An anode electrode is formed on a lower surface of the upper substrate, and a phosphor layer is formed on a lower surface of the anode electrode. A cathode electrode is formed on an upper surface of the lower substrate. The cathode electrode can have a flat shape.

An insulating layer is formed on the cathode electrode, and a plurality of parallel strip shaped gate electrodes are arranged on the insulating layer. The gate electrodes and the insulating layer respectively include gate apertures and cavities. A plurality of emitters formed of an electron emission material, for example, Carbon Nanotubes, are disposed on the cathode electrode exposed through the gate apertures. A plurality of spacers for uniformly maintaining a gap between the upper substrate and the lower substrate are disposed therebetween.

In the structure described above, electrons are emitted from the emitters disposed on the cathode electrode when a voltage is supplied between the cathode electrode and the gate electrodes. The electrons are accelerated by a voltage supplied to the anode electrode to excite the phosphor layer, thereby emitting visible light.

However, some electrons emitted from the cathode electrode accumulate at the insulating layer between the gate electrodes, and generate an arc discharge due to the high voltage supplied to the anode electrode. The arc discharge damages the backlight unit.

### SUMMARY OF THE INVENTION

The present invention provides a field emission backlight unit that prevents an insulating layer, on which electrons accumulate, from generating an arc discharge by forming the gate electrode so that the insulating layer does not face an anode electrode.

The present invention also provides a method of operating the field emission backlight unit.

According to one aspect of the present invention, a field emission backlight unit is provided including: an upper substrate and a lower substrate spaced apart from each other and facing each other; an anode electrode arranged on a lower surface of the upper substrate; a phosphor layer arranged on a lower surface of the anode electrode; cathode electrodes arranged on an upper surface of the lower substrate; an insulating layer having cavities adapted to expose the cathode electrode; a flat panel shaped gate electrode arranged on the insulating layer and having gate apertures respectively connected to the cavities; and an emitter arranged on the cathode electrode; the gate electrode is adapted to receive a ground voltage and the cathode electrode is adapted to receive a negative voltage.

The cathode electrode preferably includes a plurality of strip shaped electrodes spaced apart from each other.

A pulsed DC voltage is preferably supplied to the cathode electrode.

The cathode electrode preferably includes a conductive material adapted to transmit ultraviolet rays and the gate electrode preferably includes a conductive material adapted to prevent ultraviolet rays from passing therethrough.

The emitter preferably includes Carbon Nanotubes (CNTs).

A plurality of spacers are preferably adapted to maintain a uniform gap between the upper substrate and the lower substrate.

According to another aspect of the present invention, a method of operating a field emission backlight unit including: an upper substrate and a lower substrate spaced apart from each other and facing each other; an anode electrode arranged on a lower surface of the upper substrate; a phosphor layer arranged on a lower surface of the anode electrode; cathode electrodes arranged on an upper surface of the lower substrate; an insulating layer having cavities adapted to expose the cathode electrode; a flat panel shaped gate electrode arranged on the insulating layer and having gate apertures respectively connected to the cavities; and emitters arranged on the cathode electrodes is provided, the method including: supplying a ground voltage to the gate electrodes; and supplying a negative voltage to the cathode electrodes to emit electrons from the emitter.

Supplying a negative voltage to the cathode electrodes preferably includes supplying a pulsed DC voltage to the cathode electrodes to sequentially emit electrons from the emitters on the cathode electrode.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a cross-sectional view of a field emission backlight unit;

FIG. 2 is a cross-sectional view of a field emission backlight unit according to an embodiment of the present invention;

FIG. 3 is a graph of variations in a light emission current with an increase in a negative voltage supplied to a cathode electrode, according to an embodiment of the present invention;

FIGS. 4A through 4E are cross-sectional views of a method of manufacturing the field emission backlight unit of FIG. 2.

### DETAILED DESCRIPTION OF THE INVENTION

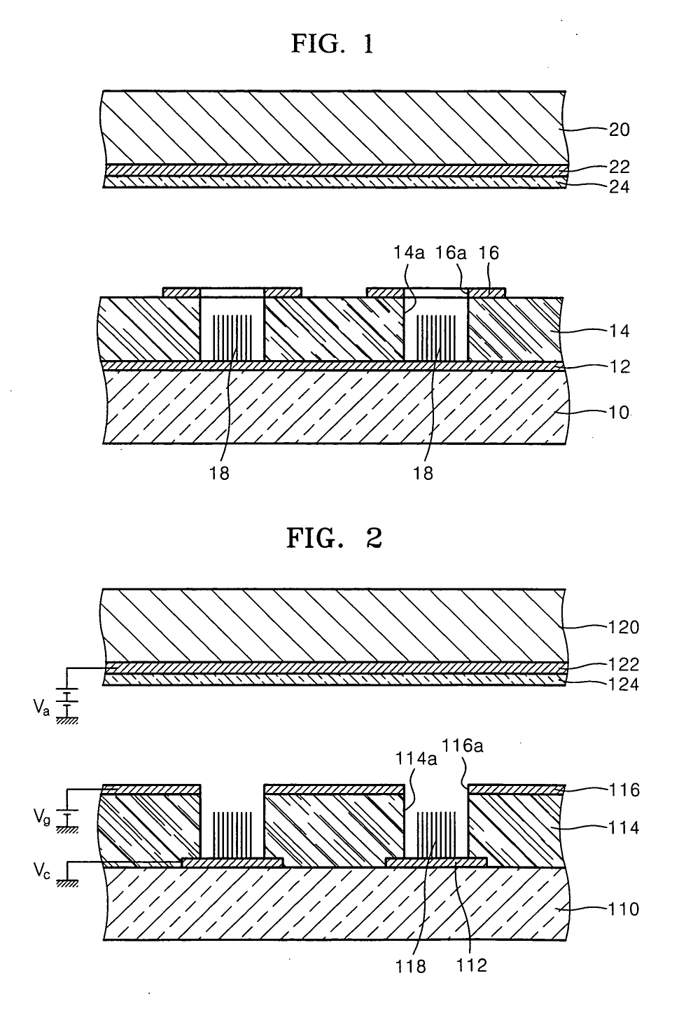

FIG. 1 is a cross-sectional view of a field emission backlight unit.

Referring to FIG. I, an upper substrate 20 and a lower substrate 10 are spaced apart and face each other. An anode electrode 22 is formed on a lower surface of the upper substrate 20, and a phosphor layer 24 is formed on a lower surface of the anode electrode 22. A cathode electrode 12 is formed on an upper surface of the lower substrate 10. The cathode electrode 12 can have a flat shape.

An insulating layer 14 is formed on the cathode electrode 12, and a plurality of parallel strip shaped gate electrodes 16 are arranged in to each other on the insulating layer 14. The gate electrodes 16 and the insulating layer 14 respectively include gate apertures 16a and cavities 14a. A plurality of emitters 18 formed of an electron emission material, for example, Carbon Nanotubes (CNTs), are disposed on the cathode electrode 12 exposed through the gate apertures 16a. Although not shown, a plurality of spacers for uniformly maintaining a gap between the upper substrate 20 and the lower substrate 10 are disposed therebetween.

In the structure described above, electrons are emitted from the emitters 18 disposed on the cathode electrode 12 when a voltage is supplied between the cathode electrode 12 and the gate electrodes 16. The electrons are accelerated by a voltage supplied to the anode electrode 22 to excite the phosphor layer 24, thereby emitting visible light.

However, some electrons emitted from the cathode electrode 12 accumulate at the insulating layer 14 between the gate electrodes 16, and generate an arc discharge due to the high voltage supplied to the anode electrode 22. The arc discharge damages the backlight unit.

The present invention is described more fully below with reference to the accompanying drawings in which exemplary embodiments of the present invention are shown. In the drawings, like reference numerals refer to like elements.

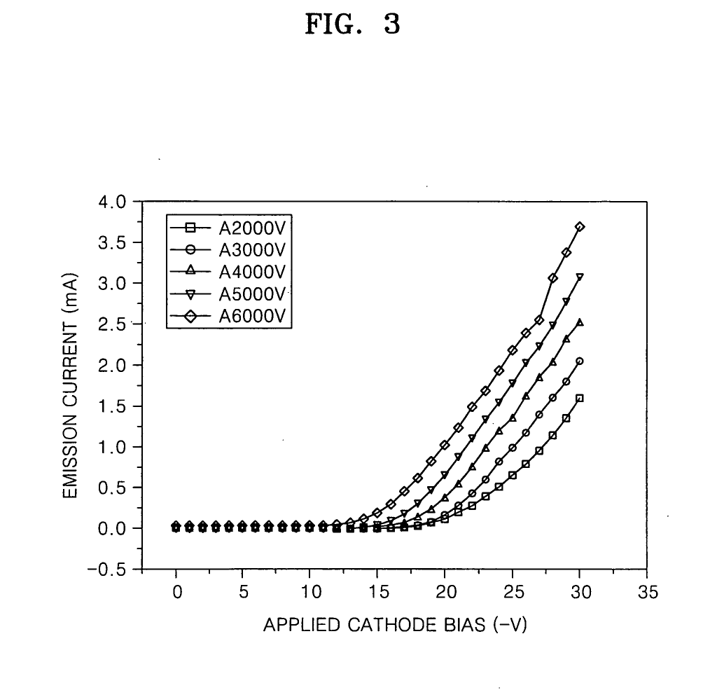

FIG. 2 is a cross-sectional view of a field emission backlight unit according to an embodiment of the present invention.

Referring to FIG. 2, an upper substrate 120 and a lower substrate 110 are spaced apart and face each other. The upper substrate 120 and the lower substrate 110 are generally formed of glass. An anode electrode 122 is formed on a lower surface of the upper substrate 120, and a phosphor layer 124 is formed on a lower surface of the anode electrode 122. The anode electrode 122 can be formed of a transparent conductive material, for example, Indium Tin Oxide (ITO), so that visible light emitted from the phosphor layer 124 can pass therethrough.

The anode electrode 122 can be formed as a thin film on the entire lower surface of the upper substrate 120. The phosphor layer 124 can be formed by respectively coating red R, green G, and blue B phosphor materials in a predetermined pattern on the lower surface of the anode electrode 122, or can be formed by coating a mixture of the red R, green G, and blue B phosphor materials on the entire lower surface of the upper substrate 120.

The strip shaped cathode electrode 112 is formed to a thickness of 1000 to 3000 Å on the surface of the lower substrate 110. The cathode electrode 112 is formed of a conductive material that can transmit ultraviolet rays, such as ITO.

An insulating layer 114 that exposes the cathode electrode 112, such as an SiO₂ layer, is formed on the lower substrate 110. The insulating layer 114 can be formed to a thickness of approximately a few to a few tens of μm, and includes cavities 114a that expose the cathode electrode 112. A gate electrode 116 having gate apertures 116a connected to the cavities 114a is formed on the insulating layer 114. The gate electrode 116 is formed as a thin film having a thickness of approximately 1000 to 3000 Å. The gate electrode 116 can be formed of a conductive material that does not transmit ultraviolet rays, such as Cr or Ag.

The gate electrode 116 can be formed in a flat shape. The gate electrode 116 prevents an arc discharge caused by collision of electrons accumulated on the insulating layer 114 with the anode electrode 122.

A plurality of emitters 118 that emit electrons in response to a voltage supplied to the cathode electrode 112 and the gate electrode 116 are formed on the cathode electrode 112 exposed through the gate apertures 116a. The emitters 118 are formed of, for example, Carbon Nanotubes (CNTs). When the emitters 118 are formed of CNTs, electrons are emitted at a relatively low driving voltage. Although not shown in FIG. 2, a plurality of spacers for uniformly maintaining a gap between the upper substrate 120 and the lower substrate 110 are disposed therebetween.

A method of operating the field emission backlight unit according to an embodiment of the present invention is as follows. To drive the field emission backlight unit having the above structure, a ground voltage Vg is supplied to the gate electrode 116 and a negative cathode voltage Vc, for example, a −60V DC pulse voltage with a period of 60 μs, is supplied to the cathode electrode 112. Thus, the current in the field emission backlight unit can be held constant and the electrons are sequentially emitted from the emitter 118 by supplying a pulse voltage to the cathode electrode 112, thereby obtaining uniform brightness from the backlight unit.

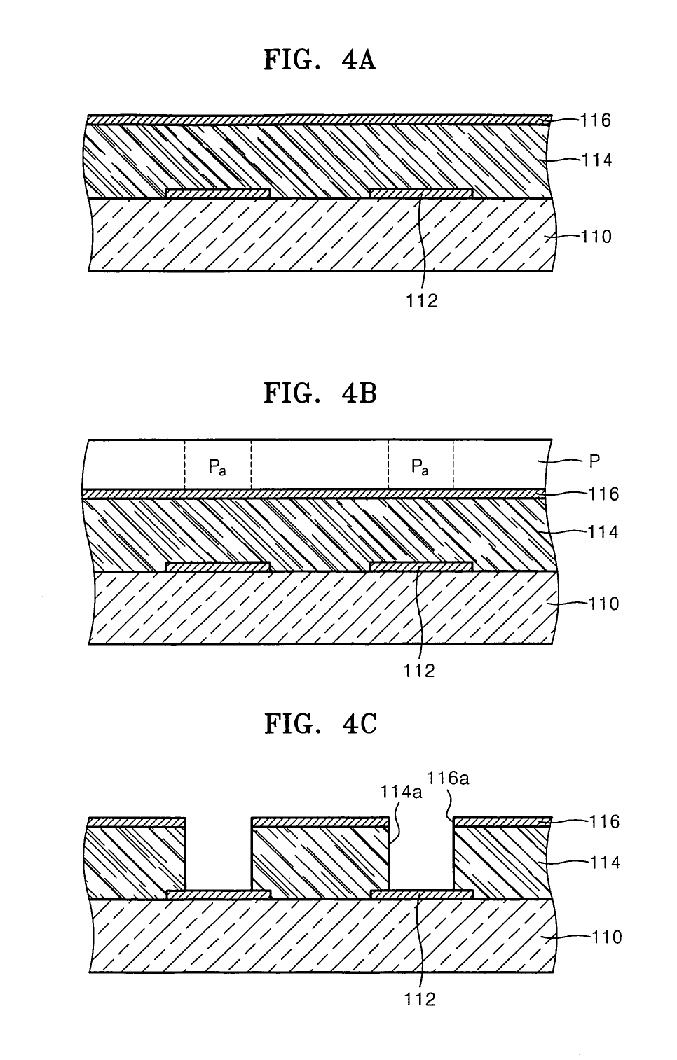

FIG. 3 is a graph of variations in a light emission current with an increase in a negative voltage supplied to a cathode electrode, according to an embodiment of the present invention. Referring to FIG. 3, a light emission current increases with the increase in the anode voltage at a constant cathode voltage, and also increases with the increase in the negative voltage of the cathode voltage. In the backlight unit of FIG. 1, a gate voltage of approximately 80V is necessary to obtain a light emission current of 2 mA when a voltage of 4 kV is supplied to the anode electrode. However, in the present embodiment, when a ground voltage is supplied to the gate electrode, a cathode voltage of approximately −27V is necessary. This shows that the field emission backlight unit according to the present invention needs a lower voltage than other backlight units to emit light with the same brightness, that is, the luminous efficiency of field emission backlight unit according to the present invention is improved. An arc discharge is not observed when an anode voltage of 10 to 15 kV is supplied to the field emission backlight unit according to the present invention.

In the field emission backlight unit according to the present invention, a high brightness can be realized by increasing an anode voltage since no arc discharge is observed at increased anode voltages.

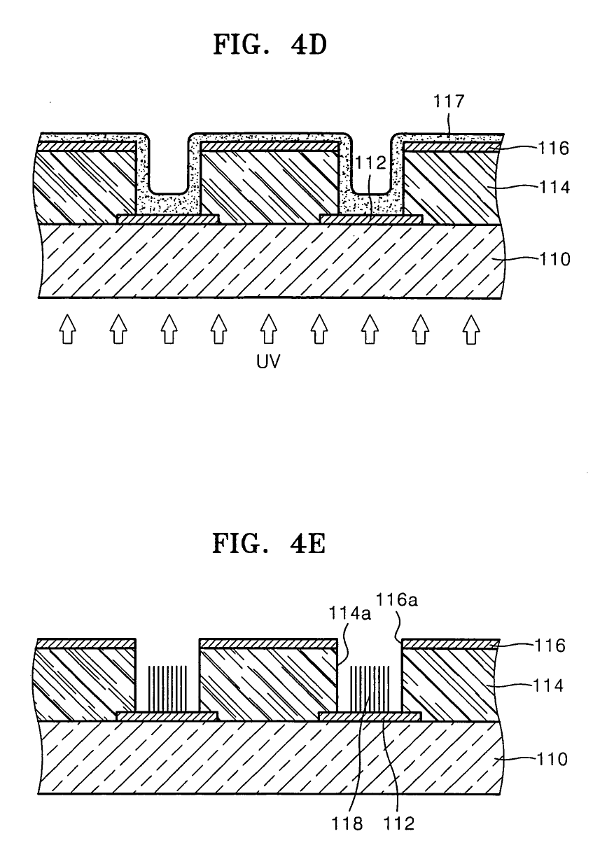

FIGS. 4A through 4E are cross-sectional views of a method of manufacturing the field emission backlight unit of FIG. 2. The same reference numerals are used for elements substantially identical with those depicted in FIG. 2, and accordingly, detailed descriptions thereof have been omitted.

Referring to FIG. 4A, after sputtering an ITO layer to a thickness of 0.25 μm on the lower substrate 110 formed of glass, a strip shaped cathode electrode 112 is formed by patterning the ITO layer. Next, an insulating layer 114, for example, an SiO₂ layer, covering the cathode electrode 112, is deposited to a thickness of a few tens of μm on the lower substrate 110. Next, a gate electrode 116 is formed on the insulating layer 114 by sputtering a Cr layer to a thickness of 0.25 μm. The purpose of forming the cathode electrode 112 using a material that transmits ultraviolet rays and the purpose of forming the gate electrode 116 using a material that does not transmit the ultraviolet rays is to perform a back exposure, which will be described later.

Referring to FIG. 4B, after coating a photosensitive film P on the gate electrode 116, a region Pa corresponding to the cathode electrode 112 is exposed.

Next, the exposed region Pa is removed through a developing process. The gate electrode 116 is exposed through the removed exposed region Pa. Gate apertures 116a are formed by wet etching the exposed portion of the gate electrode 116 using the photosensitive film P as an etch mask. Next, cavities 114a that expose the cathode electrode 112 are formed in the insulating layer 114 by etching the insulating layer 114 using the photosensitive film P as an etch mask.

FIG. 4C shows a resultant product after the photosensitive film P is removed.

Referring to FIG. 4D, after a CNT paste 117 that contains a negative photosensitive material is coated to cover the resultant product including the exposed cathode electrode 112, the CNT paste 117 on the cathode electrode 112 which is exposed in the gate hole 116a is back-exposed using ultraviolet rays through the lower substrate 110. Next, as depicted in FIG. 4E, CNT emitters 118 are formed on the cathode electrode 112 through developing and baking processes.

The next process, such as bonding the upper substrate and the lower substrate after forming the anode electrode and the phosphor layer on the upper substrate, is well known in the art, and accordingly, detailed descriptions thereof have been omitted.

As described above, a field emission backlight unit according to the present invention prevents an insulating layer from being exposed to an anode electrode by forming a flat shaped gate electrode, thereby preventing the formation of an arc discharge. Therefore, the field emission backlight unit according to the present invention can have a high brightness by supplying a high anode voltage.

Also, according to a method of operating the field emission backlight unit according to the present invention, a driving voltage can be reduced by supplying a DC pulse negative voltage to the strip shaped cathode electrode.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A field emission backlight unit, comprising:
an upper substrate and a lower substrate spaced apart from each other and facing each other;
an anode electrode arranged on a lower surface of the upper substrate;
a phosphor layer arranged on a lower surface of the anode electrode;
cathode electrodes arranged on an upper surface of the lower substrate;
an insulating layer having cavities adapted to expose the cathode electrode;
a flat panel shaped gate electrode arranged on the insulating layer and having gate apertures respectively connected to the cavities; and
an emitter arranged on the cathode electrode;
wherein the gate electrode is adapted to receive a ground voltage and the cathode electrode is adapted to receive a negative voltage.

2. The field emission backlight unit of claim 1, wherein the cathode electrode comprises a plurality of strip shaped electrodes spaced apart from each other.

3. The field emission backlight unit of claim 2, wherein a pulsed DC voltage is supplied to the cathode electrode.

4. The field emission backlight unit of claim 1, wherein the cathode electrode comprises a conductive material adapted to transmit ultraviolet rays and wherein the gate electrode comprises a conductive material adapted to prevent ultraviolet rays from passing therethrough.

5. The field emission backlight unit of claim 1, wherein the emitter comprises Carbon Nanotubes (CNTs).

6. The field emission backlight unit of claim 1, wherein a plurality of spacers are adapted to maintain a uniform gap between the upper substrate and the lower substrate.

7. A method of operating a field emission backlight unit, including:
an upper substrate and a lower substrate spaced apart from each other and facing each other;
an anode electrode arranged on a lower surface of the upper substrate;
a phosphor layer arranged on a lower surface of the anode electrode;
cathode electrodes arranged on an upper surface of the lower substrate;
an insulating layer having cavities adapted to expose the cathode electrode;
a flat panel shaped gate electrode arranged on the insulating layer and having gate apertures respectively connected to the cavities; and
emitters arranged on the cathode electrode;
the method comprising:
supplying a ground voltage to the gate electrodes; and
supplying a negative voltage to the cathode electrodes to emit electrons from the emitter.

8. The method of claim 7, wherein supplying a negative voltage to the cathode electrodes comprises supplying a pulsed DC voltage to the cathode electrodes to sequentially emit electrons from the emitters on the cathode electrode.
